(19) United States
(12) Patent Application Publication
(10) Pub. No.: US 2020/0160234 A1
(43) Pub. Date: May 21, 2020

(54) SEAT ALLOCATION SYSTEM

(71) Applicant: PROSERVID LLC, Tokyo (JP)

(72) Inventor: Masahiro KAMEURA, Tokyo (JP)

(21) Appl. No.: 16/626,655

(22) PCT Filed: Sep. 3, 2018
(86) PCT No.: PCT/JP2018/032558

§ 371 Date: Dec. 26, 2019

(30) Foreign Application Priority Data
Sep. 13, 2017 (JP) 2017-175467

(51) Int. Cl. G06Q 10/02; G06Q 20/04; G06Q 30/08; G06Q 20/12; G06F 16/2457

(52) U.S. Cl. CPC G06Q 10/02; G06Q 20/0457; G06F 16/24578; G06Q 20/127; G06Q 30/08

(57) ABSTRACT

[Problem] To ensure fairness in ticket sales by means of an auction devised to control against excessively high bids and make winning bid prices more reasonable.

[Solution] Provided is a seat allocation system comprising: an input unit 11 for accepting a purchase request with a specified bid price, in the context of selling seats; a winning bid management unit 12 for determining winning bidders on the basis of the inputted bid prices as ranked in descending order and determining a seat designation order for the determined winning bidders on the basis of the bid prices as ranked in ascending order; and a seat determination unit 13 for initiating the acceptance of input regarding desired seats according to the seat designation order and reserving seats from among the remaining seats according to the input regarding desired seats while accepting input on desired seats out of the remaining seats from the next winning bidder according to the seat designation order.

### TECHNICAL FIELD

The present invention relates to a seat allocation system for selling event tickets, seat reservation tickets for public transportation, and the like.

### BACKGROUND ART

Tickets for entertainment events such as concerts and sports, and seat reservation tickets for public transportation, etc. have been sold at ticket offices and convenience stores after setting prices in advance. However, since it is usually on a first-come-first-served basis, people who have prepared an environment where applications can be made immediately after launch can get tickets quickly, and popular items are sold out quickly, only some people repeatedly obtained tickets, while others complained that it was extremely difficult to obtain tickets.

On the other hand, there is a method in which a ticket can be applied for a certain period of time and a winner is determined by lottery. However, even in this case, there is a problem that a person who raises the winning probability appears by providing many fictitious accounts. In particular, there are many ways to join a fan club in many names for a fan club priority application. Therefore, it is preferable to win the one with higher priority by comparing the superiority of the application contents rather than simply drawing. Specifically, the auction format as described in Patent Document 1 is a format in which a person who has made a high bid makes a successful bid. It is relatively easy to understand in terms of price formation based on supply and demand.

### RELATED ART DOCUMENTS

### Patent Documents

Patent literature 1: Japanese Patent No. 3872307

### SUMMARY OF THE INVENTION

On the other hand, the auction format has a problem that the winning bid price is likely to rise. For ticket sellers, the higher the price, the better in some case. But, in particular, for entertainment events, there are many prestigious events held as part of the fan service. Therefore, the fact that a good seat is allocated by a person who has invested a large amount of money has a problem that it is hard for ordinary fans to feel fairness.

Therefore, by a mechanism that suppresses bidding at abnormal price levels while reflecting demand and supply in the price through an auction format, and by a mechanism that prevents the fixation of customers in favorable seats, a sales system was required that would ensure the fairness of ticket sales.

The seat allocation system of the present invention comprises, input means to accept purchase application by specifying bid price when selling seats, successful bid management means for determining the winning bidder based on the order of the entered bid prices, determining the seat assignment order based on the order of the low bid prices among the determined successful bidder, assigning seat assignment time according to the seat assignment order; a seat determination means for accepting an input of a desired seat for the remaining seats to the successful bidder in the order of lower seat assignment, accepting the input of the desired seat from the successful bidder within the assigned seat time, executing the reservation of the seat according to the desired seat input from the remaining seats,

### Effects of the Invention

According to the present invention, tickets can be sold in a rational manner based on supply and demand, and the unfair feeling that a person who has played with a trick can preferentially obtain tickets can be eliminated. On the other hand, since low price bidding is motivated for the order of seat assignment, bidding at an optimal price is promoted, and as a result, price increases can be suppressed. In addition, liquidation can be expected for those who have favorable seats. Therefore, it is possible to realize ticket sales with a high sense of fairness in both the successful bidder of the ticket and its price.

### BRIEF DESCRIPTION OF THE DRAWINGS

FIG. 1 is a system configuration diagram according to the present embodiment.

FIG. 2 is a block diagram showing a functional configuration according to the present embodiment.

FIG. 3 is a diagram showing processing for a system by a seller and a user.

FIG. 4 is a diagram showing an event registration screen.

FIG. 5 is a diagram showing a bid execution status.

FIG. 6 is a diagram showing a process for determining a successful bid and a seat assignment order.

FIG. 7 is a diagram showing a list of seat assignment ranks and seat input times.

FIG. 8 is a diagram showing a login process of a seat assignment screen.

FIG. 9 is a diagram showing a seat assignment screen.

FIG. 10 is a flowchart showing seat determination processing.

### DESCRIPTION OF THE EMBODIMENTS

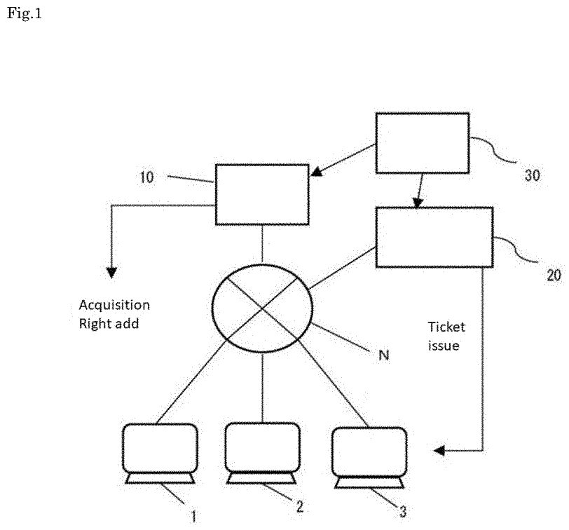

FIG. 1 is a system configuration diagram according to the present embodiment. The ticket sales system according to this embodiment is configured by connecting user terminals 1 to 3 and a ticket issuing server 20 to a seat management system 10 via a network. The seat management system 10 is actually composed of a WEB server, an application server, a database server, and the like that operate on different hardware, and it is considered that an operation mode in which each is connected via a network is common, but, for convenience of explanation, they are explained here as an integral unit. Furthermore, the user terminal includes a terminal of the operation manager when the operation manager performs an operation on behalf of the user by telephone or customer service at the store.

The seat management system 10 accepts applications from user terminals 1 to 3, i.e. bids, determines the winning bidder and price for the winning bidder, the seat management system 10 decides the starting order of seat assignment, assign seat reservation time, and notifies the winning bidder with the winning bid result. For the seat selected from the remaining seats within the assigned seat time, a ticket acquisition right is issued as a reservation for the successful bidder, and the ticket issuing server 20 is notified.

The ticket issuing server 20 performs an authentication process in response to a request from the user, and performs a ticket issuing process for the seat reservation person in accordance with the seat acquisition right. Specific hardware configurations of the seat management system 10 and the ticketing server 20 are as follows.

(About the Hardware Configuration of this System)

Each of the seat management system 10 and the ticketing server 20 includes a CPU (Central Processing Unit), a ROM (Read Only Memory), a RAM (Random Access Memory), an image processing unit, and an external storage device. The CPU, ROM, RAM, image processing unit, and external storage device are connected to each other via a bus.

The CPU executes various processes according to a program recorded in the ROM or a program loaded from the external storage device to the RAM. The RAM appropriately stores data necessary for the CPU to execute various processes.

The image processing unit consists of a GPU (Graphics Processing Unit) or DSP (Digital Signal Processor), VRAM (Video Random Access Memory), etc., various image processing is performed on the image data in cooperation with the CPU.

The external storage device may be any storage medium such as a DRAM, cache memory, magnetic disk, optical disk, magneto-optical disk, or semiconductor memory. External storage devices include not only those connected via a bus but also those that are read and written via a drive. The data stored in this embodiment will be described as being temporarily stored in the RAM, both in the case of temporary storage and in the case of long-term storage using a nonvolatile memory.

An input/output interface is connected to each of the seat management system 10 and the ticketing server 20. A display unit, an imaging unit, an input unit, and a communication unit are connected via an input/output interface. The input unit includes a keyboard, a mouse, various buttons, and the like, and receives an instruction operation. The communication unit controls communication performed with other devices via a network including the Internet.

The display unit has a display screen and has a display device that displays and reproduces the image or video formed by the image processing unit. As the display device, various display devices such as a monitor and a liquid crystal display are assumed. In the present embodiment, image data to be displayed is generated by a CPU or the like, and image display processing is performed on the display screen via the image processing unit. Henceforth, when only “display” is described, it includes executing display processing including the above functions.

The seat management system 10 and the ticket issuing server 20 each have the above-described configurations, and the functional configurations will be described later respectively. Each functional configuration is functionally realized by the cooperative operation of the CPU, ROM, RAM, image processing unit, and external storage device. The function of each of these units is a module configuration provided by an electronic circuit or a program, the program is stored in a ROM or an external storage device and is executed by cooperating with each unit while being appropriately read out by the CPU.

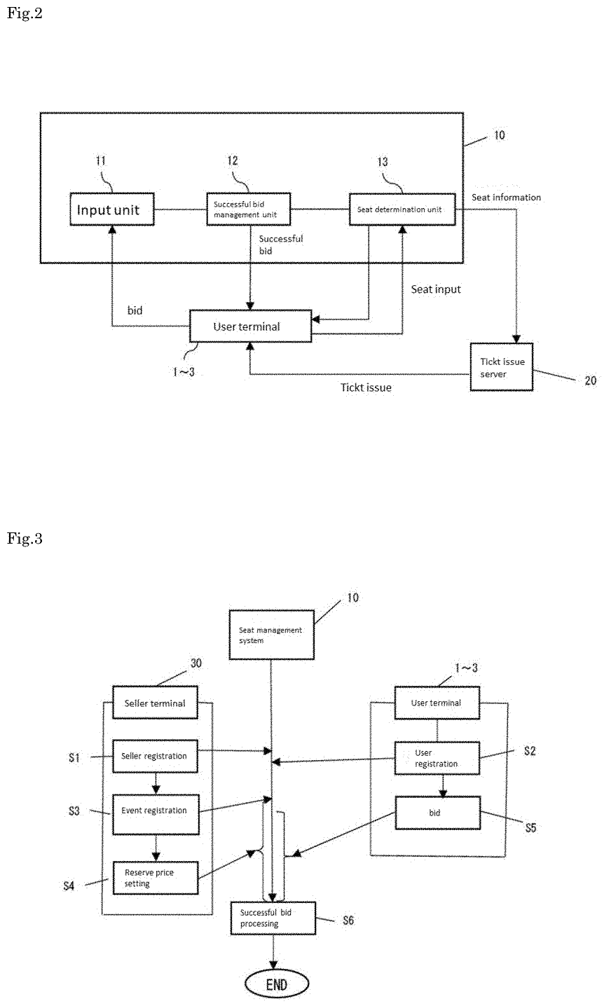

FIG. 2 is a block diagram showing a functional configuration according to the present embodiment. The seat management system 10 includes the following functional configuration as a seat allocation system in order to perform a successful bid and seat determination process as described above. The seat management system 10 includes an input unit 11, a successful bid management unit 12, and a seat determination unit 13.

(Bid Processing)

The input unit 11 accepts an application for purchase in the form of a bid from the user terminals 1 to 3 when selling a seat. A bid price and an allowable minimum grade of the seat are input to the input unit 11. The seats may consist of multiple grades, for example, in the case of an event held on the stage, it is divided into S seat, A seat, B seat, C seat, and the S seat is the closest to the stage and is easy to see. The A seat, the B seat, and the C seat become the hard-to-see seats away from the stage in this order. An individual seat cannot be specified at the bidding stage.

When S seat is assigned as the allowable minimum grade, a successful bid judgment is made only within the limited number of S seats, if the S seat is not successful, even if it is possible to make a successful bid for seat A or lower, the bid is determined as a non-successful bid. When A seat is assigned as the allowable minimum grade, a successful bid judgment is made within the range of the limited number of S seats and A seats, If a successful bid can be made at the A seat, even if it is not successful at the S seat, the bid is considered to have been made for the A seat and the successful bid is at the A seat. In this way, the minimum grade that accepts a successful bid is set as the allowable minimum grade, and the input is accepted together with the purchase application. In addition, since it is possible to pay up to 20000 Yen for the S seat but only 12000 Yen for the A seat, it may be possible to set a bid for each grade as an option.

Since the bid price can be freely set, the reserve price can be set as the lowest bid price at the discretion of the seller. When there are few bidders as free input, for example, a bid may be made by bidding for 100 yen. In order to prevent such a bid that is too low, a reserve price can be set to invalidate bids less than the reserve price. Conversely, a prompt decision price can be set as the highest bid price. When a bid is made at a prompt decision price, it will be a successful bid. The prompt decision price will be described later.

(Successful Bid Processing)

The successful bid management unit 12 determines the winning bidder and the price for each seat grade by the Dutch auction method based on the bid price and the allowable minimum grade from among the accepted bids. Dutch auction is an auction lowering the price until a limited number of bids that meet the price condition, making a successful bid to applying to all bids above the price at the time when limited number is reached. For example, if the number of tickets is 3 and the bids are 10,000 yen, 9000 yen, 8000 yen, and 7000 yen, the 10,000, 9000, and 8000 yen bids will be sold at 8000 yen, and the 7000 yen bid will be unsuccessful. If there are multiple bids of the same amount, a method to cancel before reaching the limited number, a method to rank according to the bidder's attributes, etc., or a method to expand the limited number and so on is used. As for the price, a second price method can be added to the Dutch auction, and the highest bid price among unsuccessful bidders or a slightly higher price than the highest bid price of the unsuccessful bidder can be applied to all successful bidders.

Alternatively, the successful bid management unit 12 may obtain a converted price by applying a coefficient determined based on the purchase category to the input bid price and may determine the winning bidder in descending order of the converted price. For example, if a conversion rate of 90% is set for seniors, bidding at 9000 yen will be handled in the same way as an ordinary 10,000 yen bidding. When a conversion rate of 50% is set for juniors, bidding at 5000 yen is treated the same as an ordinary 10,000 yen bidding.

As described above, the successful bid management unit 12 first performs the highest grade successful bid processing based on the order of the input bid prices, next, for the bid that was not successful in the highest grade, the next grade was processed, the winning bidder and price for each grade will be determined from the upper grade to the lower grade. Of course, the order of winning bids according to the bid price is of course included in the order of winning bids according to the converted price after multiplying a certain coefficient. It also includes the case where a part of the successful bid order goes up and down depending on certain conditions on the assumption of the order of money amount.

(Determining the Seat Assignment Order for the Highest Grade)

Then, the successful bid management unit 12 determines the seat assignment order in order from the lowest bid price including the converted price for the highest-grade successful bidder. Rather than accepting seat assignments all at once, by starting to accept inputs in a preset order, even within the same seat grade, a person with a fast seat assignment order can assign a good seat. The winning bidder is notified of the assigned seating time according to the seating order determined in this way together with the winning bid grade and winning bid price, and a bidder who cannot make a successful bid is notified of a non-successful bid. It is set to accept the input of the desired seat in order of the descending grade such that at the time of seat assignment, it becomes possible to assign the seat of the highest grade successful bidder first, and that after the deadline for seat assignment of the highest grade successful bidder has arrived, the seat assignment of the next grade successful bidder can be made.

Here, instead of simply assigning the seat assignment order from the lowest bid price, for example, by giving a certain weight to those who have won the fan club benefits, some successful bidders can prioritize seat selection over other low bidders. For example, since the front of the S seat is also a conspicuous seat, for who to sit in that prominent seat, since some items have a higher priority than simply determining the amount of money, considering this point, it is possible to realize seat determination in consideration of the circumstances of the event organizer.

In addition, after determining the winning bidder using the converted price, it is also possible to increase the priority for bidders with specific attributes, by determining the seat assignment order using the bid price before conversion.

As described above, the successful bid management unit 12 determines the seat assignment order for the highest-grade successful bidder based on the bid price in ascending order. Of course, to arrange the order of seat assignment according to the order of the amount of money includes, of course, to arrange the order of seat assignment along the order of the amount of money after multiplying a certain coefficient. It also includes the case where the order of seat assignment rises and falls depending on certain conditions, assuming the order of money.

(Determination of Seat Assignment Order for Lower Grades)

The above description was about the process of determining the seat assignment order in the highest grade such as the S seat. But as long as all grades are processed in the same auction, bids at higher prices are automatically processed as higher-grade bids, a different method can be used for the determination processing of the lower grade seat assignment order.

For example, the successful bid management unit 12 determines the seat assignment order in order from the highest bid price including the converted price for the winning bidder of the grade lower than the highest. This makes it easier for bidders who are dismissed by a slight difference to accept the successful bid result because they can obtain the best conditions for the next grade. In addition, in the lowest grade, bidding with an amount that is too low is unlikely to occur.

As described above, in this embodiment, although only the highest grade successful bidder is given a seat assignment order in ascending order of bid price, in some cases, it may not be denied that it may be desirable for the winning bidders other than the highest grade to arrange the seat assignment order in ascending order of the bid price. However, even in such a case, it is possible to easily cope with this by making it possible to select a processing method for each grade in the initial setting items of the seller.

(Processing of the Seat Determination Unit 13)

The seat determination unit 13 accepts an input of a desired seat for a successful bidder for a assigned seat time, and the successful bidder inputs a desired seat from the user terminals 1 to 3. The seat determination unit 13 reserves a seat according to the desired seat input from the remaining seats.

In this way, the seat determination unit 13 accepts the input of the desired seat for the remaining seats to the successful bidder in the descending order of lower seat assignment.

In principle, the S-successful bidder assigns the S-seat and the A-seat successful bidder assigns the A-seat. On the other hand, there is a case where the seat desired by the successful bidder of the S seat is in the A seat. For example, if one wants to have multiple seats for an event side by side, but if they are already occupied, he/she may place importance on serial numbers even a little behind.

In this case, the processing is possible such that the seat determination unit 13 allows the successful bidder of the highest seat grade to input the desired seat about the remaining seats assigned as lower seat grades (trade system), and allows the winning bidder of the lower seat grade to enter the desired seat only for the number of empty seats generated by the trade for the upper grade seat, not to allow more input.

For example, the first screen displayed for the successful bidder in the S seat is the S seat, but by the switching process of the display screen, a switching input for displaying the A seat and, in some cases, the B seat is accepted. Then, the successful bidder of the S seat can assign the A seat or a lower grade seat by a process such as designating the A seat on the A seat display screen.

In this way, if a higher-grade successful bidder is allowed to select a lower grade seat, there are not enough lower grade seats and the upper grade seats will be left. So, to successful bidders of the next grade, in addition to the seats of each grade below the successful bid grade, the seats of the higher grades that still have vacant seats due to trade can be displayed.

Although one will not be able to enter his/her preferred seat until the assigned seat time has arrived, when the time comes and he/she tries to enter a seat, his/her desired seat may be occupied. Therefore, when a login to the system is requested outside the assigned time, including the time before the seat assigned time, browsing of the seat confirmation status can be permitted.

By this, it is possible to smoothly determine the seat without hovering or getting impatient when it comes to his/her turn and without causing the resulting discomfort. Conversely, for those who have not made a successful bid, seat determination information is unnecessary information, and by allowing access only to the winning bidder, unnecessary user access can be restricted.

(Issuance of Acquisition Rights and Ticketing Processing)

For the seat reserved as described above, the seat determination unit 13 outputs data for mailing the seat ticket to the registered address of the seat reservation person. Alternatively, an acquisition right for acquiring a ticket for the seat is issued to the seat reservation person. Although tickets can be handled as a purchase right because they are mainly acquired through purchases, in addition to purchasing rights, there may be some priority status that is not in cash or vouchers, in the present embodiment, including these, it will be described as an acquisition right. The acquisition right is issued to the seat reservation person by a mechanism for preventing impersonation by a third party including, for example, an authentication code, a password, and other information for authenticating the seat reservation person.

At the same time, seat assignment information including these pieces of information is sent from the seat management system 10 to the ticket issuing server 20. The seat reservation person issues a ticket through the ticketing server 20 with this acquisition right. The ticket issuing server 20 includes, an authentication server used by an online ticket as well as, for example, a ticket issuing system such as a ticket agency and a convenience store for purchasing tickets.

(Sequential Flow to Successful Bidder Decision)

Hereinafter, a series of flows will be shown taking sales of event tickets as an example. FIG. 3 is a diagram showing processing for a system by a seller and a user. The seat management system 10 receives access from each of the user terminals 1 to 3 and the seller terminal 30. At first, since it is necessary to perform system registration for each of the seller and the user, the seller registers the seller with the seat management system 10 from the seller terminal 30 (S1).

On the other hand, the user performs user registration from the user terminals 1 to 3 (S2). At the time of user registration, the user's personal information is received, identity verification is performed to record the result together. If identity verification is made at a later date, provisional registration is required until identity verification is completed. In addition, payment by deposit may be required at the time of user registration or after registration and subsequent bids can be restricted to set the amount within the range of the deposit amount deposited in advance.

The seller registered as a seller registers an event for the ticket to be sold (S3). When registering an event, basic information regarding the target event is entered, as well as basic information related to the auction, such as a bidding period for purchasing a ticket, a successful bid date, a seat assignment period, and a reserve price. In addition, as an option, the upper limit of the highest bid is set in advance only for the highest grade, a so-called prompt decision price can be set for promptly determining the bidder as a successful bidder when a bid is made at the upper limit price. In this case, the prompt price is set and input in advance from the seller terminal 30 to the seat management system 10 at the time of event registration (S3). Various information that has been input will be announced with some exceptions and will wait for the start of the bidding period.

In order to fully understand the series of procedures, bids will be accepted after a known period. When the bidding is closed and the winning bidder is determined, a seat assignment period will be established. Although in normal ticket sales, tickets are often issued immediately after purchase, in this embodiment, since there are two stages of bidding and seat assignment, there is a possibility that some people forget to assign seats. Therefore, the seat assignment procedure and method are also made known in advance by showing them as event information.

FIG. 4 is a diagram showing an event registration screen. At the time of event registration in step S3, event registration is performed from the seller terminal 30 via the screen as shown in FIG. 4. In the case of FIG. 4, contents common to all grades, such as an event name and an event holding place, are input in order from the top, and then contents for each grade are registered. The grade of the seat is divided into three grades, S, A and B from the top. For grade S, the number of seats is to 500 and the reserve price is set to 12,000 yen. For grade A, the number of seats is set to 1000 and the reserve price is set to 5000 yen. For grade B, the number of seats is set to 5000 and the reserve price is set to 3000 yen.

Furthermore, as an option, a discount on the amount can be set for each attribute of the bidder. For example, in the case of a bidder set with a conversion rate of 90%, a bid of 10,000 yen can be made at 9000 yen. In other words, it is a priority treatment setting that allows low-priced bids high-priced bids effect. When the general rate is 100%, the conversion rate of 90% for seniors, 50% for juniors, and 80% for FC (fan club) members is set in the example of FIG. 4.

Returning to the flow of FIG. 3, when the bidding period specified in the event registration (S3) has arrived, a bid for a ticket is accepted from the user terminals 1 to 3 (S5). In order to meet the desire to purchase tickets for the entire family, it is possible to accept bidding by specifying a plurality of tickets and specify different attributes for each. However, the converted price and the allowable minimum grade are the same respectively. In addition, the number of bids per person or per household will be limited.

When a bid is placed, the allowable minimum grade, bid price, and attributes of the seat are registered as bid data together with the bidder identification information. If the bid price is a prompt decision price or higher, the bid is processed with successful bid processing as a prompt decision (S6). The bid is accepted during the bidding period, and the successful bidder is determined after the bidding period ends (S6). As for the successful bid of the tickets, for example, when 700 bids are made for 500 tickets, the auction format in which the highest 500 tickets are awarded is adopted in order from the top.

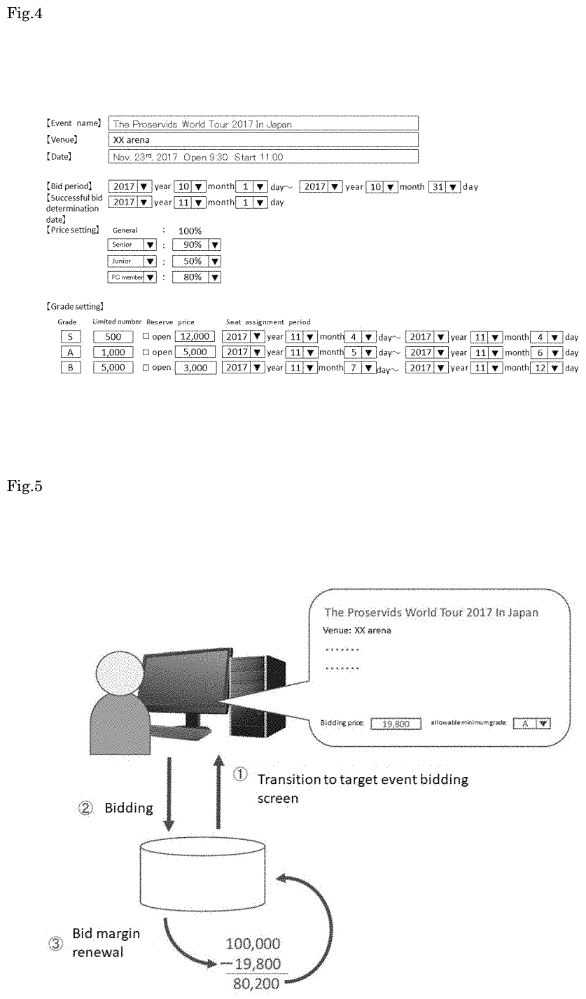

FIG. 5 is a diagram showing the execution status of bidding. A user logs in to the event registered with the content shown in FIG. 4 from the user terminal 1 and makes a bid. When a user logged in, the screen transits to the target event bidding screen, where various information related to the event such as the event name and venue name are displayed, and the bidding screen is displayed together with a list of ticket grades.

Next, bid is made. When adopting the deposit system, each user deposits money in advance of the bid amount or more by deposit, and bids within the deposit amount range. In this example, a deposit of 100,000 yen is made as a deposit and a bid is made for 19,800 yen. When a bid is made, the bid margin is updated, and the difference of 80,200 yen becomes the new bid margin. As the deposit amount will be confirmed at a later date, the deposit and the bidding capacity are displayed side by side.

Returning again to the flow of FIG. 3. The seller can set or change the reserve price at any time before the successful bid (S4) even if the bidding (S5) has started. That is, the seller can set the reserve price so as to maximize the profit based on the bid result. Or, when the number of bids is small, it is possible to increase the number of successful bidders to the last line that does not become deficit. However, if the reserve price is disclosed, change only for price down is possible and cannot be raised halfway.

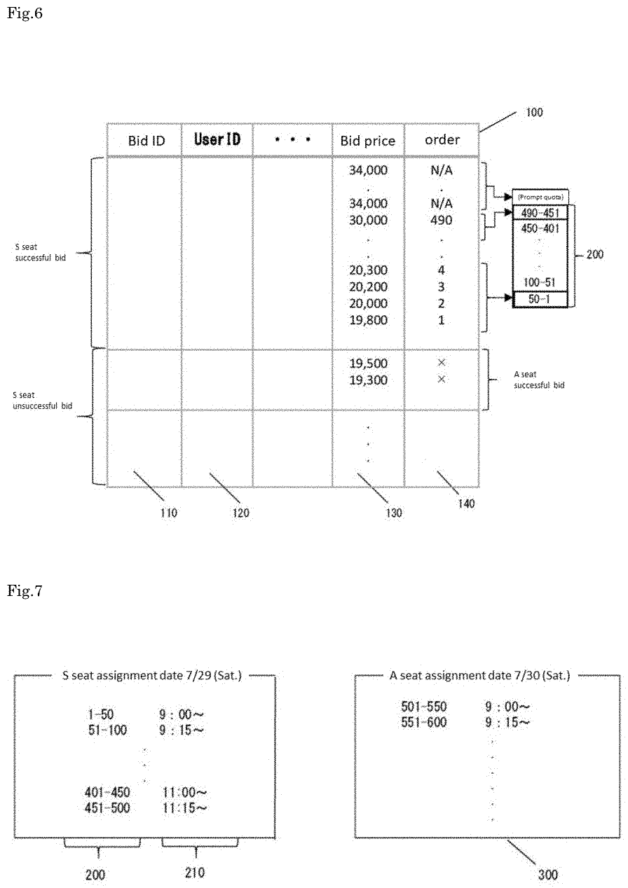

FIG. 6 is a diagram illustrating a process for determining a successful bid and a seat assignment order. When a bid is made, the bidder's user ID (120) is linked to the bid ID (110) together with bid information such as price and allowable minimum grade, and registered as bid data in a data source such as a DB. In this case, when a bid is made at the prompt decision price, information for confirming the successful bid is registered together.

When the bidding period ends, the process proceeds to successful bid processing. Even if the bidding period does not end, if all the tickets are bid at the prompt decision price, all the tickets have been awarded, so the bidding period ends. After the bidding period is over, as a successful bid process, the bidding list is sorted according to the bid amount for all bids, and the winning list 100 is created. The winning list 100 does not necessarily output such a table but may be created virtually in memory.

In the winning list 100, the highest bid amount is placed at the top, and the bid amount is gradually sorted in the descending order. The example of FIG. 6 shows a case where the prompt decision price for the S seat is 34,000 yen, and there are 10 bids at the prompt decision price, that is, 10 maximum bids. Since the number of tickets for the S seat is 500, the winning bid is determined as the winner of the S seat for the top 500 bids.

If the bid order is more than 501, the S seat will be lost, but the lower grade seat may be won. If it was possible to win seat A at that bid amount while seat S did not reach, and if the bidder had entered an acceptable minimum grade as seat A or seat B, the bid can be elected to A seat. In the case of the example shown in FIG. 6, for bids of 19500 yen and 19300 yen, the S seat is lost, while the A seat is won. On the other hand, the maximum allowable grade cannot be set, and the highest grade that can be awarded at the bid price is always automatically applied.

After determining the winning bidder as described above, the next process of determining the seat assignment order is performed. As shown in FIG. 6, the top 500 successful bidders in the S seat are assigned, but the seat assignment order is assigned in order from the lowest bid amount, not from the highest bid amount. The order of seat assignment is the order of time in which the seats can be assigned. The first order in the seat assignment order can assign the seat first, and the second order can assign the seat next.

Here, for the sake of convenience in 15-minute increments in the example of FIG. 7 to be described later, seat assignment time is assigned to each group of 50 people. Of course, the seat input time may be assigned individually for each person, and by setting the seat input start time in increments of 1 minute or 15 seconds, a unique start time can be assigned for each person. In that case, consideration is given to log in at just the right time, by such as displaying a clock on the login screen. The winning bidder is notified of the winning bid information thus determined, that is, the winning bid grade, the winning bid price, and the seat assignment time.

In the example of FIG. 6, as the bidder at the lowest price among the successful bidders in the S seat is the person who bid at 19800 yen, the ranking is assigned such that this bidder is ranked first and the next bidder at 20000 yen is ranked second. Excluding those who bid at the prompt decision price of 34,000 yen, the bidder at 30000 yen is the highest bidder, so ranks up to 490 are assigned. In addition, for the successful bidder of the prompt decision price, the entry of the seat assignment is not permitted, and when the seat assignment of that grade is closed, Along with other normal successful bidders who have not been able to assign seats for some reason, the remaining seats of that grade are simply assigned by lottery.

Each 50 successful bidders are grouped for the winning bidders ranked first to 490 as determined above. The 1st to 50th positions are the first group, the 51st to 100th positions are the second group, and so on, and the 451st to 500th positions (strictly 490th in this example) are the 10th group. Each group does not necessarily have the same number of people. For example, if there are 10 bids in the 98th place, the second group was ranked to 97th, the third group was ranked from 98th, and one of the three excessive people is assigned to the fourth group, The third group may be assigned to the 149th place, and the fourth group may be assigned to the 200th place.

FIG. 7 is a diagram showing a list of seat assignment order and seat input date and time. After determining the groups for each seat assignment order 200 as described above, the seat assignment time 210 is assigned to each group. The seat assignment dates will be determined for each grade and announced beforehand. Among them, an early seat assignment start time 210 is assigned when the seat assignment order 200 is upper, and a later seat assignment start time 210 is assigned when lower.

As shown in FIG. 7, for the first group in which the seat assignment order 200 is 1st to 50th, seat assignment starts from 9:00. The first group can input any time after 9:00 until the seat assignment time limit for the S seat, but if it is too late, the successful bidder of the later group will be able to determine the seat first. At 9:15, acceptance of seat input for the second group begins. In this way, seat assignment start time 210 of the last 10th group, whose seat assignment order 200 is 451 to 500 (490) is assigned from 11:15.

The left diagram in FIG. 7 is for the case of the S seat, but the right diagram shows the example 300 for the A seat. The seat A is not particularly different from the case of the S seat, but the seat assignment date and time is set after the seat assignment deadline for the S seat. Further, although not shown in the drawing, the same is set for the B seat.

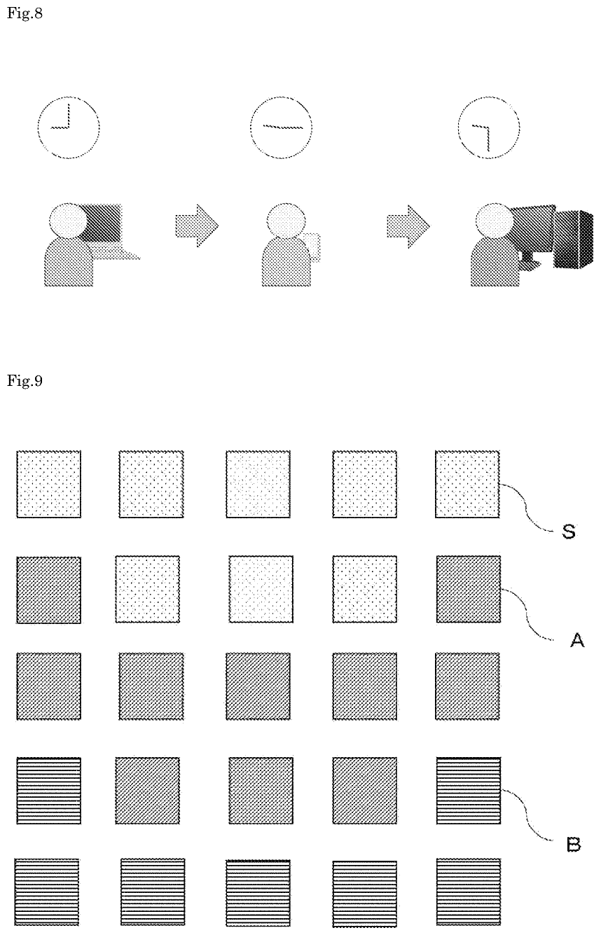

FIG. 8 is a diagram illustrating a login process of the seat assignment screen. For example, regarding S seat, a user of user terminal 1 is assumed to seat assignment order 20th of the 1st group, a user of user terminal 2 is assumed to seat assignment order 70th in the 2nd group, and a user of user terminal 3 is assumed to seat assignment order 120th in the 3rd group. At 9 o'clock, the terminals 1 of the first group assigns seats. At 9:15, the user terminals 2 of the second group assigns a seat. At 9:30, the user terminal 3 of the third group assigns a seat. As shown in FIG. 8, the terminal is not limited to a personal computer, and various devices, can be used that can input and have a communication function, such as a smart phone and a tablet.

FIG. 9 is a diagram showing a seat assignment screen. The S seat is the seat closest to the stage most suitable for viewing, the A seat is assigned next, and the B seat is assigned the most economical seat. In this way, while the seats of the venue are assigned, a desired seat is input and registered from the vacant seats of the successful bid grade or lower. The successful bid grades may be set to grades that differ only in the seat assignment order, such as the S1 grade that is allowed to preferentially assign seats to the S seat, and the S2 grade that is allowed to assign S seats following the S1 grade.

Normally, all seats are sold out, but sometimes they remain unsold. In other words, if the total number of active bids that were bid at a price higher than the reserve price in a grade (excluding bids that were awarded in the higher grade) does not reach the planned number of tickets of that grade, the ticket is left over. In addition, it is assumed that advance sales are performed at an auction and then general sales are performed by a normal sales method. In such a case, resale outside the auction, that is, re-offering is performed. In re-offering, people can purchase unsold tickets at the winning bid. Note that the selling price may be lower than this at the discretion of the seller. Re-offering continue until sold out, and the remaining unsold portion is allocated to the same day ticket.

Since for those who won the auction, the seat assignment time has already been determined, the order of seat assignment for buyers in re-offering will be assigned after that. In the re-offering, tickets are sold in the order of first-come-first-served basis, and the order of purchase is the order of seat assignment. The re-offering will not end even after the seat reservation deadline has passed and will continue until just before the event.

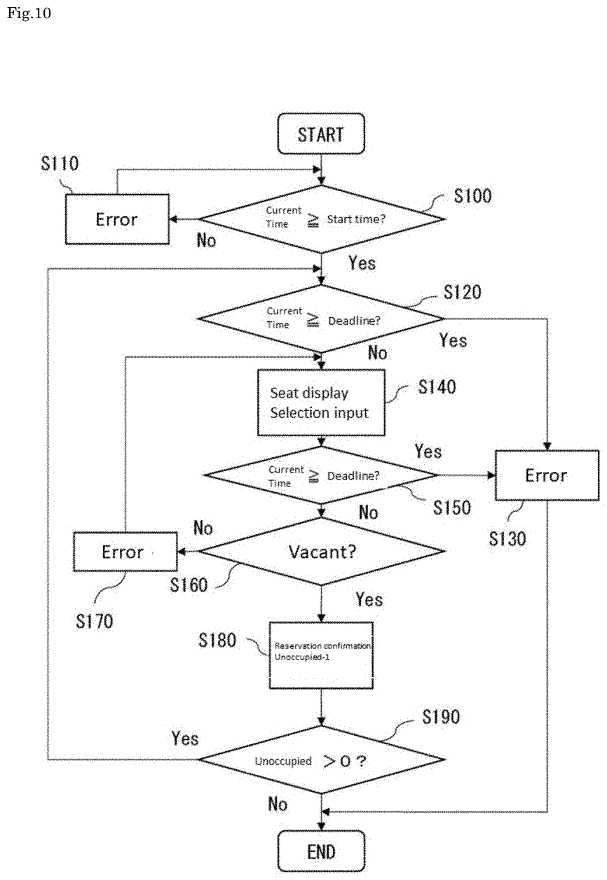

FIG. 10 is a flowchart showing seat determination processing. The seat assignment process after a successful bid has already been described with reference to each drawing, but this will be described in time series using a flowchart. The processing is executed by the seat determination unit 13. As a flow, seat assignment input is continued according to successful bit grades, and according to seat assignment order in each grade.

First, the seat determination unit 13 compares the current time with the seat assignment start date and time for each successful bidder (S100). When the current time is before the successful bidder's seat assignment start date and time, an error message is displayed (S110), and the seat assignment start date and time is waited. If the current time is after the successful bidder's seat assignment start date and time, the current time is compared with the seat assignment deadline of the successful bid grade (S120).

If the current time is after the seat assignment time limit for that grade, an error message is displayed (S130), and the process ends. If the current time is before the seat assignment deadline for that grade, the seating chart is displayed, and the input of the desired seat is accepted (S140).

The seat determination unit 13 compares the current time with the seat assignment time limit for that grade again (S150), as deadline of seat assignment deadline may arrive till then after receiving input data tor desired seat. If the current time is after the seat assignment time limit for that grade, an error message is displayed (S130) and the process ends.

If the current time is before the seat assignment time limit for that grade, it is determined whether the seat is vacant (S160). This is because even if the seat is vacant when the user terminal reads the seat display screen, there is a possibility that someone will make a reservation before the seat assignment input. If the seat is not vacant, an error message is displayed (S170) to prompt the user to assign another seat again. If the seat is vacant, the input seat is confirmed as a reserved seat, and 1 is subtracted from the number of unoccupied seats of the successful bidder (S180).

Then, the number of unoccupied seats is determined (S190). If the number of unoccupied seats is 1 or more, a series of seat assignment processes are repeated, and the processing is terminated when the number of unoccupied seats becomes zero.

This process is repeated for all grades in order from the upper grade. When the seat assignment time limit for the lowest grade has arrived, the series of processes ends as there is no next grade.

As described above, according to the present embodiment, a high bid that is far from the winning bid works disadvantageously at the time of seat determination, overall the increase in the winning bid price can be suppressed. In addition, as fixation of customer of the favorite seats is difficult, and fair ticket sales becomes possible.

Although this invention has been demonstrated using the Example as above, the technical scope of this invention is not limited to the range as described in the said Example. It will be apparent to those skilled in the art that various modifications and improvements can be made to the above-described embodiments. It is apparent from the description of the scope of claims that embodiments with such changes or improvements can be included in the technical scope of the present invention.

### DESCRIPTION OF THE REFERENCE NUMERALS

1-3 User terminals
10. seat management system
11. input unit
12. successful bid management unit
13. seat determination unit
20. ticket issuing server
30. seller terminal

1. A seat allocation system comprising:
an input means for accepting an application for purchase with a designated bid price when selling a seat selectable ticket;
successful bid management means for
determining the winning bidder based on the order of the entered bid prices,
determining the seat assignment order based on the order of the low bid prices among the determined successful bidders,
and assigning seat assignment time according to the seat assignment order;
seat determination means for sequentially executing the reservation of the seat by allowing the successful bidder to enter the desired seat from the remaining seats within the assigned seat time.

2. The seat allocation system according to claim 1,
wherein the ticket has a grade and the successful bid management means determines a successful bidder for each grade based on the bid price,
wherein for the winning bidder for at least one of the grades, the order of seat assignment is determined based on the order of the lower bid prices, and
wherein the seat determination means sequentially executes the reservation of the seats by allowing the successful bidder to input a desired seat from the remaining seats within the seat assignment time.

3. The seat allocation system according to claim 2,
wherein the seat determination means allow the higher-grade winning bidder to enter the desired seat for the remaining lower grade seats, in the case where a seat area is assigned by the grade,
and the lower grade winning bidder to input of a desired seat for a remaining seat of a higher grade, only the vacant seats generated by the higher-grade winning bidder assigning a lower grade seat.

4. The seat allocation system according to claim 1,
wherein the successful bid management means obtains a converted price by multiplying a coefficient determined based on the purchase application to the input bid price and determines winning bidders in descending order of the converted price.

5. The seat allocation system according to claim 4,
wherein the successful bid management means determines the seat assignment order for the determined successful bidder in ascending order of the conversion price.
